(19) United States
(12) Patent Application Publication
(10) Pub. No.: US 2010/0119087 A1
(43) Pub. Date: May 13, 2010

(54) MEMS MICROPHONE DEVICE

(76) Inventor: Norio Kimura, Kanagawa (JP)

Correspondence Address: MCDERMOTT WILL & EMERY LLP, 600 13TH STREET, NW, WASHINGTON, DC, 20005-3096, US

(21) Appl. No.: 12/526,744

(22) PCT Filed: Jan. 21, 2008
(86) PCT No.: PCT/JP2008/050713

§ 371 Date: Aug. 11, 2009

(30) Foreign Application Priority Data
Feb. 14, 2007 (JP) 2007-033297

(51) Int. Cl. H04R 25/00

(52) U.S. Cl. 381/174

(57) ABSTRACT

The invention provides a MEMS microphone device capable of improving the S/N ratio of output signals in the MEMS microphone and obtaining flat frequency characteristics up to a high range, for which reflow mounting is enabled. The MEMS microphone of the present invention includes a MEMS chip for converting an acoustic signal to an electric signal, a shield for covering the MEMS chip, and a deemphasis circuit for applying a deemphasis process to a signal output from the MEMS chip, wherein the shield is configured so as to apply a preemphasis process to the signal input to the MEMS chip.

### TECHNICAL FIELD

The present invention relates to a MEMS microphone device having a MEMS chip using a micro-machining technology.

### BACKGROUND ART

Conventionally, there have been Electret Condenser Microphones (ECM) using an organic film as one of the microphones used for information communication terminals such as a mobile phone. The ECM is a microphone having an electret disposed at one electrode of a condenser, which converts changes in the electrostatic capacitance fluctuating by acoustic pressure into changes in voltage with electric charge given to the electret.

In recent years, demands have been made to reduce the mounting cost of the ECM along with further downsizing and thinning thereof. Since the conventional ECM uses electret materials made of organic materials that are weak against heat as described above, the conventional ECM cannot meet solder reflow surface mounting. Also, the ECM is attached to a substrate by means of connectors provided to the ECM, therefore, the cost is required for the connector components.

In view of the above, a small-sized microphone (MEMS microphone) using a micro-machining technology in which a semiconductor technology is utilized has been proposed. FIG. 7 shows a sectional structure of the MEMS microphone.

As shown in FIG. 7, a MEMS microphone 200 has a vibration film electrode 23 and an electret film 24 on a silicon substrate 21 via the first insulative layer 22. Further, the MEMS microphone 200 has a fixed electrode 26 having an acoustic hole 27 formed therein via the second insulative layer 25 thereon. Also, a cavity 28 is formed on the backside of the vibration film electrode 23 by etching the silicon substrate 21.

The vibration film electrode 23 is formed of a conductive polysilicon, and the electret film 24 is formed of silicon nitride film and silicon oxide film. In addition, the fixed electrode 26 is formed by stacking conductive polysilicon, a silicon oxide film and a silicon nitride film.

If the vibration film electrode 23 vibrates in accordance with acoustic pressure in the MEMS microphone 200, the electrostatic capacitance of a plate capacitor having the vibration film electrode 23 and the fixed electrode 26 changes to output the changes in voltage.

Thus, since the MEMS microphone 200 uses an electret material of inorganic material, reflow mounting that was impossible in prior art ECM is enabled. Also, the number of components thereof can be reduced, and at the same time, downsizing and thinning thereof can be achieved (Refer to patent Document 1).

Patent Document 1: JP-A-2001-245186

Non-Patent Document 1: [Chee Wee et al “Analytical modeling for bulk-micromachined condenser microphone” JASA vol. 120, August, 2006]

### DISCLOSURE OF THE INVENTION

### Problems to be Solved by the Invention

When a MEMS microphone is mounted in, for example, a next generation (3G or 4G) mobile phone, mainly, influences due to white acoustic thermal noise (Refer to Non-Patent Document 1) resulting from acoustic resistance of an acoustic equivalent circuit of the MEMS microphone chip cannot be ignored. It is necessary to further improve the S/N ratio (Signal-to-Noise ratio). Also, in the next generation mobile phones, frequency characteristics in which the frequency is flat in a further higher range (for example, 3.5 kHz through 7 kHz) are required.

However, since prior art MEMS microphones are used in a state where the MEMS microphones are covered by a shield case having an acoustic hole formed therein in order to prevent influences of electromagnetic waves from other electronic circuits when being mounted on a substrate, there may be cases where the frequency characteristics of the MEMS microphones are changed from the characteristics designed in advance.

In order to prevent the same, there is means for providing an acoustic resistance material on the acoustic hole of the shield case. However, with respect to the acoustic resistance material, acoustic resistance materials that can sufficiently withstand heat (260° C. at maximum and about four seconds) of reflow mounting have not been developed yet. Therefore, since the characteristics are spoiled due to being deformed upon receiving heat, the reflow mounting cannot be carried out.

The present invention is developed in view of the above-described problems, and it is therefore an object to provide a MEMS microphone device capable of improving the S/N ratio of output signals and of obtaining flat frequency characteristics up to a high range, for which reflow mounting can be achieved.

### Means for Solving the Problem

A MEMS microphone device according to the present invention includes a MEMS chip for converting an acoustic signal to an electric signal, a shield for covering the MEMS chip, and a deemphasis circuit for applying a deemphasis process to a signal output from the MEMS chip. The shield is configured so as to apply a preemphasis process to a signal input to the MEMS chip.

According to the configuration, since, in the MEMS microphone device, a preemphasis process is carried out by the structure of the shield, it is not necessary to provide any electronic circuit for the preemphasis process. Further, it is possible to exclude influences due to noise of the electronic circuit for preemphasis. In addition, since a deemphasis process is carried out with respect to the output signal, the frequency characteristics of the MEMS microphone can be flattened to a higher range than in prior arts. Further, according to the configuration, since no acoustic resistance material is used, reflow mounting is enabled.

Further, in the MEMS microphone device according to the present invention, the shield applies the preemphasis process by using an acoustic hole provided on the shield, and a front air chamber formed by the shield and a front air chamber formed by the shield and a substrate on which the shield is mounted.

With the configuration, it is possible to control the preemphasis characteristics, that is, the frequency area to be emphasized, for example, by adjusting the size of the acoustic hole and the size of the entirety of the shield.

### EFFECTS OF THE INVENTION

With the MEMS microphone device according to the present invention, the S/N ratio can be improved, frequency characteristics in which the frequency is flat to a high range can be obtained, and reflow mounting can be carried out.

### BRIEF DESCRIPTION OF THE DRAWINGS

FIG. 1 is an appearance perspective view of a MEMS microphone 100 according to Embodiment 1 of the present invention;

FIG. 2 is a longitudinally sectional view (sectional view taken along the line A-A in FIG. 1) of the MEMS microphone 100;

FIG. 3A is a side view of the MEMS microphone 100, and FIG. 3B is a plan view of the MEMS microphone 100;

FIG. 4 is a view showing frequency characteristics of output signals of the MEMS chip 102;

FIG. 5 is a view describing a change in frequency characteristics where the diameter of acoustic hole is changed;

FIG. 6 is a view describing the results of having executed preemphasis and deemphasis processes; and

FIG. 7 is a longitudinally sectional view of a prior art MEMS microphone.

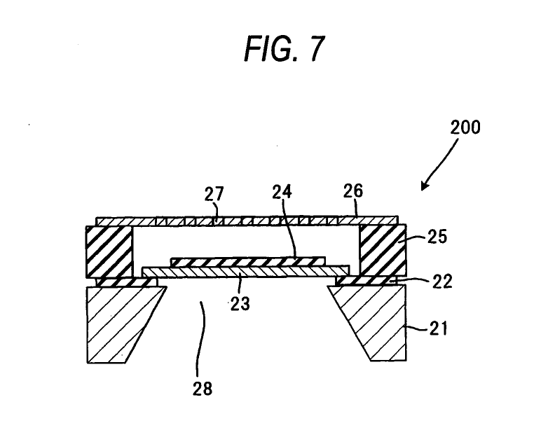

### DESCRIPTION OF REFERENCE NUMERALS

100 MEMS microphone
101 Substrate
102 MEMS chip
103 Shield case
103a Top plate
103b Side plate
103c Acoustic hole
S Front air chamber
48 Electric circuit

### BEST MODE FOR CARRYING OUT THE INVENTION

Hereinafter, a description is given of an embodiment of the present invention with reference to the drawings.

### Embodiment 1

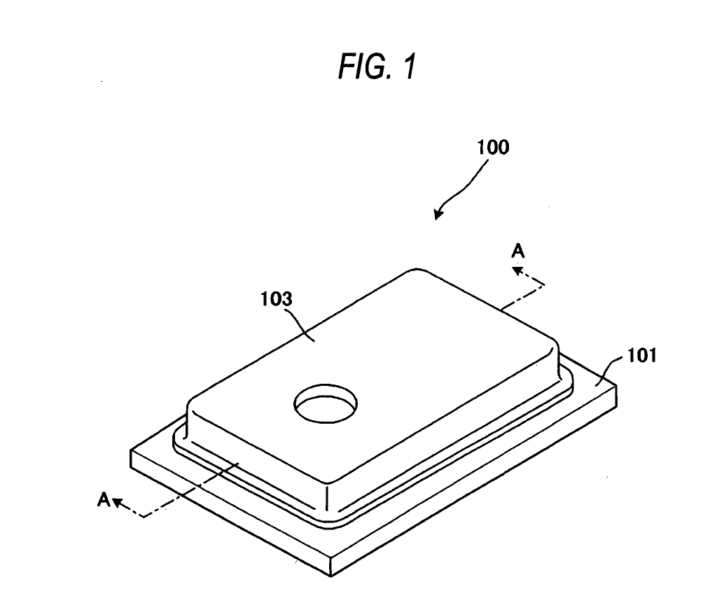

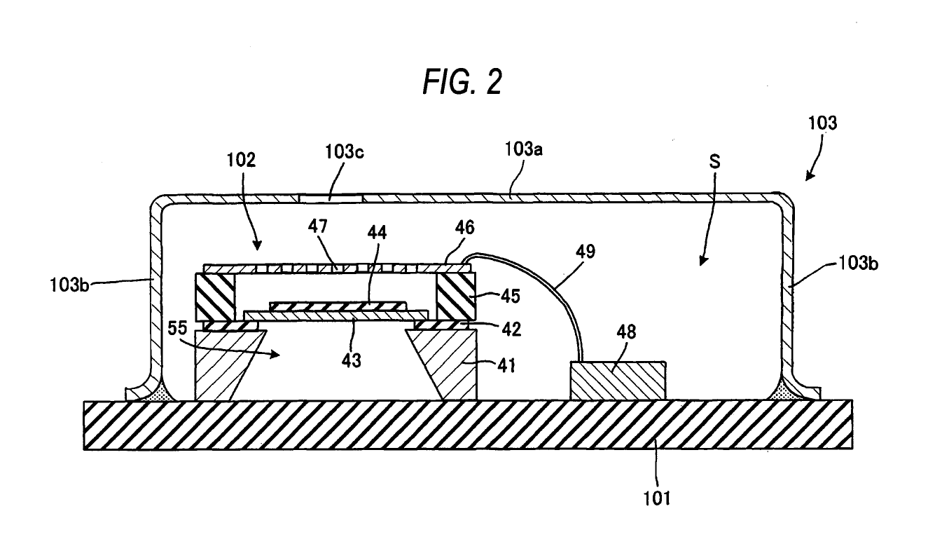

FIG. 1 is an appearance perspective view of a MEMS microphone 100 according to Embodiment 1 of the present invention, and FIG. 2 is a longitudinally sectional view (sectional view taken along the line A-A in FIG. 1) of the MEMS microphone 100. As shown in FIG. 1 and FIG. 2, the MEMS microphone 100 includes a substrate 101, a MEMS chip 102 and a shield case 103.

The substrate 101 is a printed circuit board on which the MEMS chip 102 is mounted.

The MEMS chip 102 converts acoustic signals, which are obtained by a vibration film electrode 43 as shown in FIG. 2, to electric signals. In detail, the MEMS chip 102 has the vibration film electrode 43 and an electret film 44 on a silicon substrate 41 via the first insulative layer 42, and it has a fixed electrode 46 having an acoustic hole 47 therein via the second insulative layer 45 thereon. Also, a cavity 55 is formed on the backside of the vibration film electrode 43 by etching the silicon substrate 41. Further, a MEMS (Micro-electromechanical system) means an electromechanical system composed of minute components manufactured by using a micro-machining technology for semiconductors.

The vibration film electrode 43 is formed of conductive polysilicon, the electret film 44 is formed of silicon nitride film and silicon oxide film, and the fixed electrode 46 is formed by stacking conductive polysilicon, silicon oxide film and silicon nitride film.

In addition, an electronic circuit 48 for executing signal processing such as amplification of electric signals of the MEMS chip 102 is electrically connected by a wire 49. The MEMS chip 102 and the electronic circuit 48 are covered by the shield case 103.

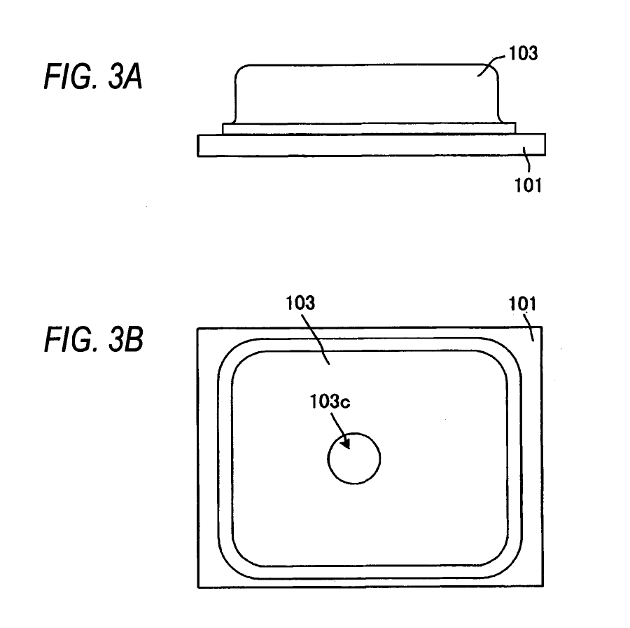

Next, a description is given of the shield case 103. FIG. 3A is a side view of the MEMS microphone 100, and FIG. 3B is a plan view of the MEMS microphone 100.

As shown in FIG. 2 and FIGS. 3A and 3B, the shield case 103 includes a top plate 103a that has four round corners and is roughly rectangular, and four side plates 103b. The material of the shield case is a metallic material having an electric shield such as, for example, nickel silver (alloy made of copper, zinc, and nickel), kovar, 42 aroma, etc. Also, the shield case may be subjected to surface treatment such as, for example, Ni plating in order to obtain junction with a substrate by soldering.

Further, a circular acoustic hole 103c is formed in the top plate 103a of the shield case 103.

The MEMS microphone 100 thus constructed has preemphasis characteristics by an acoustic structure that is configured by a front air chamber S formed of the substrate 101 and the shield case 103, and the acoustic hole 103c formed in the shield case 103.

Generally, the preemphasis means modulation of a specified frequency component of modulation signals by emphasizing the same in order to improve the S/N ratio of the demodulated signals. However, the preemphasis characteristics referred to herein mean the characteristics in which the high range of signals are emphasized, regardless of modulation and demodulation of the signals.

Further, the deemphasis characteristics mean characteristics in which the high range of signals is attenuated, regardless of modulation and demodulation of signals.

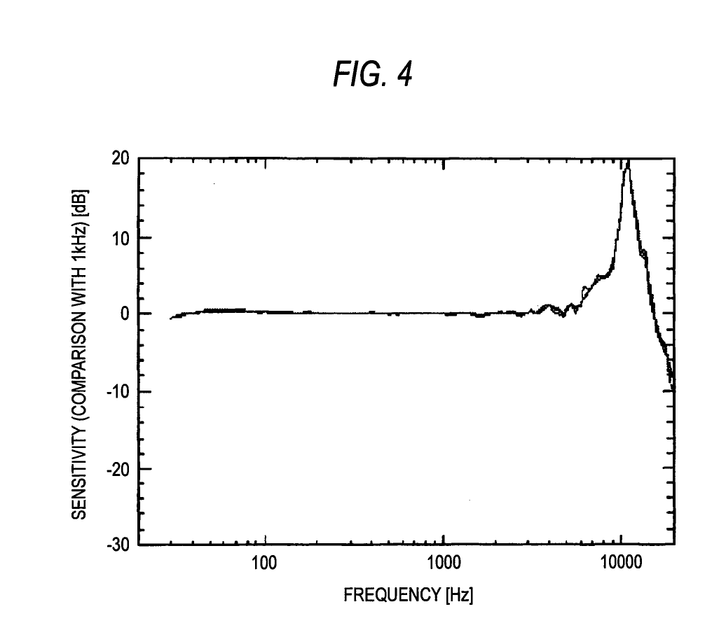

FIG. 4 shows frequency characteristics of signals that, where an acoustic source is located outside the MEMS microphone, acoustic signals transmitted from the acoustic source pass through the acoustic hole 103c of the shield case 103, reach the MEMS chip 102 inside the shield case, are converted to electrical signals and then are output. As shown in FIG. 4, it is understood that the signals reached the MEMS chip 102 are emphasized in a high range by influence of the acoustic structure formed by the front air chamber S and the acoustic hole 103c.

Usually, there is means for flattening the frequency characteristics using an acoustic resistance material in the acoustic hole in order to deny the characteristics. However, in the MEMS microphone 100 according to the present embodiment, the characteristics are grasped as preemphasis in the signal processing. When preemphasis is carried out in an electronic circuit, noise of the electronic circuit may influence the preemphasis. In the present embodiment, since the preemphasis is carried out by the structure of the shield case, no influence due to noise of the circuit will be brought about.

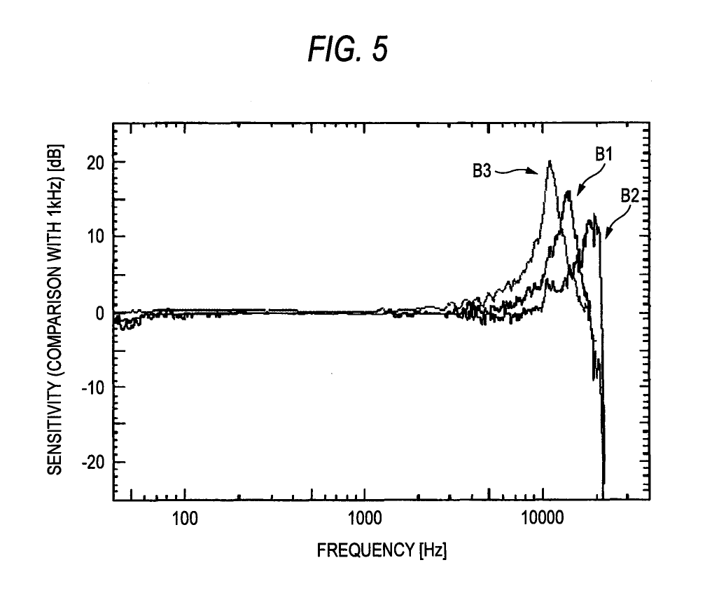

FIG. 5 is a view describing a change in frequency characteristics where the diameter of an acoustic hole is changed. Graph B1 in FIG. 5 shows the frequency characteristics where the diameter of the acoustic hole 103c is made to 0.5 mm, graph B2 shows the frequency characteristics where the diameter of the acoustic hole 103c is made to 0.8 mm, and graph B3 shows the frequency characteristics where the diameter of the acoustic hole 103c is made to 1.0 mm. Also, in the respective graphs, the conditions other than the diameter of the acoustic hole are the same.

Based on the drawing, it is understood that the frequency characteristics can be controlled by adjusting the diameter of the acoustic hole. That is, where the frequency characteristics are grasped as preemphasis, it is understood that the preemphasis characteristics based on the acoustic structure formed of the front air chamber S and the acoustic hole 103c can be adjusted by adjusting the diameter of the acoustic hole 103c provided in the shield case 103. In other words, the emphasis characteristics can be controlled by the impedance design of the acoustic hole 103c and the front air chamber S.

Thus, it is possible to adjust the preemphasis process applied to the signals before being input to the MEMS chip 102 by changing the diameter of the acoustic hole 103c.

Now, returning to FIG. 2, an electronic circuit 48 is also provided in the shield case 103. Signals of the MEMS chip 102 are output to the electronic circuit 48. The electronic circuit 48 carries out a deemphasis process corresponding to the preemphasis process carried out by the acoustic structure. The electronic circuit 48 may be an integrated circuit having the deemphasis characteristics.

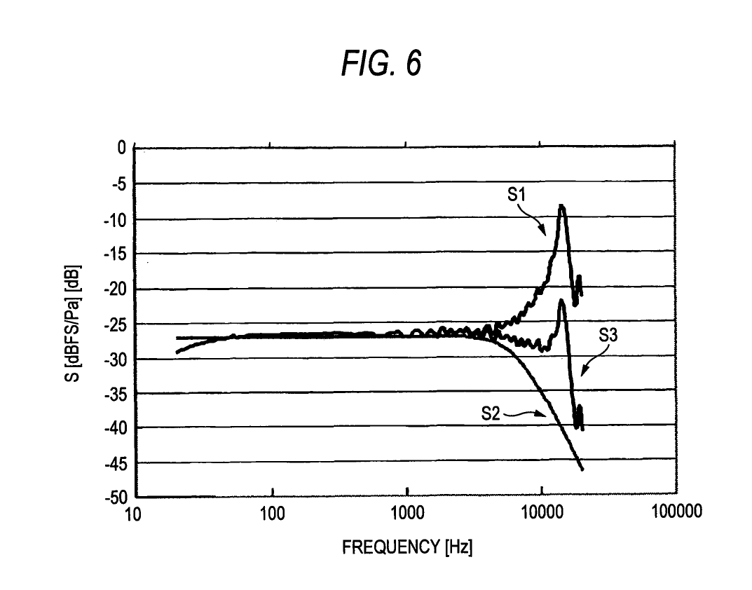

FIG. 6 is a view describing the results of the preemphasis and deemphasis processes. In FIG. 6, reference symbol S1 shows the preemphasis characteristics by the structure of the shield case 103, S2 shows the deemphasis characteristics (Electric deemphasis Q=0.7, fc=6.5 kHz) by the electronic circuit 48, and S3 shows the result of having carried out both the preemphasis and deemphasis processes.

As shown in FIG. 6, by carrying out the preemphasis and deemphasis processes, flat frequency characteristics can be obtained up to a high range with respect to the output of the MEMS chip 102, that is, the output signals of the MEMS microphone 100. Simultaneously, white acoustic thermal noise resulting from acoustic resistance of an acoustic equivalent circuit of the MEMS microphone chip is limited with respect to the bandwidth by electrically limiting the bandwidth by means of the deemphasis, such that the high range noise is reduced, and the S/N ratio is improved.

As seen from FIG. 6, the S/N ratio is improved by 2 [dB] or more in a high range, and noise is reduced. This is a particularly useful result with respect to a 3G/4G mobile phone.

Thus, since, in the MEMS microphone 100 according to Embodiment 1, mainly, white acoustic thermal noise resulting from acoustic resistance of an acoustic equivalent circuit of the MEMS chip 102 is reduced by applying a deemphasis process to signals output from the MEMS chip 102, the S/N ratio can be improved. Also, since, in the MEMS microphone 100, the preemphasis process is carried out by the structure of the shield case 103, it is not necessary to provide an electronic circuit for preemphasis, wherein influence due to noise of the electronic circuit for preemphasis can be excluded. In addition, the frequency characteristics of the MEMS microphone 100 can be flattened to a higher range than in prior arts by carrying out a deemphasis process to the output signals. Further, according to the configuration, reflow mounting is enabled since no acoustic resistance material is used.

Still further, the present invention may be applicable not only to analog microphones but also to an analog portion of a digital microphone having digital output.

The present invention is also described in detail with reference to a specified embodiment. However, it is obvious to one skilled in the same art that the present invention may be subject to various modifications and variations without departing from the spirit and scope of the present invention.

The present application is based on Japanese Patent Application No. 2007-033297 filed on Feb. 14, 2007, the contents of which are incorporated herein for reference.

### INDUSTRIAL APPLICABILITY

The present invention is effective as a MEMS microphone capable of improving the S/N ratio and obtaining flat frequency characteristics up to a high range, for which reflow mounting is enabled.

1. A MEMS microphone device comprising:
a MEMS chip that converts an acoustic signal to an electric signal;
a shield that covers the MEMS chip; and
a deemphasis circuit that applies a deemphasis process to a signal output from the MEMS chip,
wherein the shield is configured so as to apply a preemphasis process to a signal input to the MEMS chip.

2. The MEMS microphone device according to claim 1, wherein the shield applies the preemphasis process by using an acoustic hole provided on the shield, and a front air chamber formed by the shield and a substrate on which the shield is mounted.
